(19) United States
(12) Patent Application Publication
(10) Pub. No.: US 2011/0105271 A1
(43) Pub. Date: May 5, 2011

(54) CONTINUOUS TRANSMISSION BY PLANETARY GEARHEAD

(76) Inventors: José Flores Braum Ballester, Porto Alegre (BR); Adriano Magistrali Ballester, Porto Alegre (BR)

(21) Appl. No.: 12/934,142

(22) PCT Filed: Feb. 17, 2009
(86) PCT No.: PCT/BR2009/000047

§ 371 Date: Jan. 19, 2011

(30) Foreign Application Priority Data
Jun. 17, 2008 (BR) PI08014345-3

(51) Int. Cl. F16H 1/28

(52) U.S. Cl. 475/331

(57) ABSTRACT

Continuous transmission by planetary gear-head referring to a mechanical transmission box (1), composed by one or more satellite gear head boxes (2) connected to the input (3) and output (4) for gears (5). The inversion of the movement, increase or decrease of the speed of rotation of the satellite boxes (2) are obtained by screws (6) connected to the same and driven by an electric motor or other source of mechanical rotation and controlled by a microprocessor, programmed with specific algorithms for each gear of the transmission box (forward, neutral and reverse).

### FIELD OF THE INVENTION

The present invention relates, in general, to the technological field of mechanical transmissions and refers, more specifically, to a transmission developed to change rotations between input (engine rotation) and output (differential, cardan axis or wheels) through one or more planetary gear heads controlled externally by screws. This transmission was developed for use in cars, motorcycles, trucks, bus and any equipment that has a transmission box between engine and output of rotation, including also machines and industrial equipments, like lathe and similars.

### KNOWN STATE OF ART

The state of art of this technological field basically comprises tree main types of transmission apparatus: manual transmission, automatic transmission and continuously variable transmissions, like the toroidal CVT. All of this transmission apparatus have the objective of change the speed ratio between the engine and the vehicle wheels as the speed of the car increases or decreases.

Both the manual transmission and the automatic transmission present fixed ratio to each gear. This transmission boxes use a range of gears—from low to high—to make more effective use of the engine's torque as driving conditions change. Interlocking toothed wheels are used to transmit and modify rotary motion and torque. A combination of planetary gears creates all of the different gear ratios that the transmission can produce, typically four forward gears and one reverse gear. When this type of transmission cycles through its gears, the driver can feel jolts as each gear is engaged. The gears can be engaged manually or automatically—using hidraulic fluid.

The toroidal CVT—continuously variable transmission—don't have a gear box with a set number of gears. It operates on a system that allows an infinite variability with no discrete-steps or shifts. This transmission uses a disc connected to the engine, a second disc connected to the drive shaft and power rollers or wheels located between the discs to transmit power from one disc to the other. The wheels can rotate along two axes and touch the discs in different areas, so a tilt of the wheels changes the gear ratio in a continuous way.

All this conventional transmission systems have problems and deficiencies. In the set gear boxes—manual or automatic—the main problem occurs in the change of gear, where the acceleration and deceleration of the engine generate a great fuel consumption and constant component consumption. These boxes require the use of complex mechanisms for each gear (forward, neutral and reverse), as well as the use of clutch.

The toroidal CVT, besides the use of a very complex mechanism for each gear, also presents serious problems of component consumption, result of the high friction between discs and wheels, requiring the use of special lubricants.

### SUMMARY OF THE INVENTION

The present invention relates to an innovative conception to change relations of gear in a transmission system, obtained through one or more planetary gear heads connected between the entrance of rotation and exit of rotation. This planetary gear heads are controlled externally by screws and according to their position it's possible to change the gear ratio in a continuous way, without the use of the complex mechanical apparatus or the component consumption that happens in a normal CVT. Through this set of gears is possible to use the input rotation to change the output rotation, finding the best rotation and speed to obtain the greatest fuel economy with the smaller detrition of the engine.

The first objective of the present invention is to provide continuously variable speed ratios (without shift of gear), through a transmission apparatus that can be adapted to any kind of engine, including combustion or electric ones, eliminating the use of clutch and the existence of a complex mechanism for selection of motion forward, neutral and reverse. The proposed invention also eliminates all the thongs, discs or pulleys of the mechanism, as well as the need to use special lubricant.

The second objective of the present invention is obtain the decrease in the number of parts needed to manufacture the transmission, with a correspondent reduction of weight and volume of the same, as well as a reduction of the manufacture costs.

The invention also aims the simplification of the procedures for the user. Once it eliminates the shift of gears and the use of the clutch it makes the act of driving easier.

### BRIEF DESCRIPTION OF THE DRAWINGS

FIG. 1 is a top view of one of the possible embodiments of the present invention.

FIG. 2 is a perspective view of a part of the first embodiment of the invention.

FIG. 3 is a schematic drawing showing the overall operation of the present invention, in which are represented the input rotation of the engine A, the satellite B, the planetary C, the satellite D and the planetary E, that transmit the movement to the wheels.

FIG. 4 is a schematic drawing of the transmission box in the neutral position.

FIG. 5 is a schematic drawing of the transmission box operating in reverse gear.

FIG. 6 is a schematic drawing of the transmission box operating in forward gear.

FIGS. 7 to 9 are comparative graphs of the conventional transmission box and the transmission of the present invention.

### DETAILED DESCRIPTION OF THE INVENTION

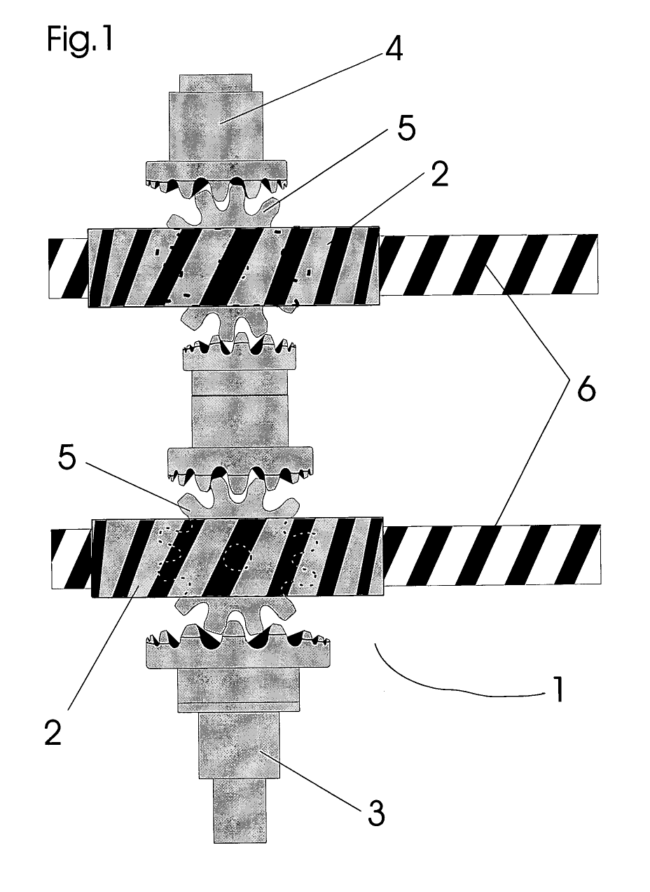

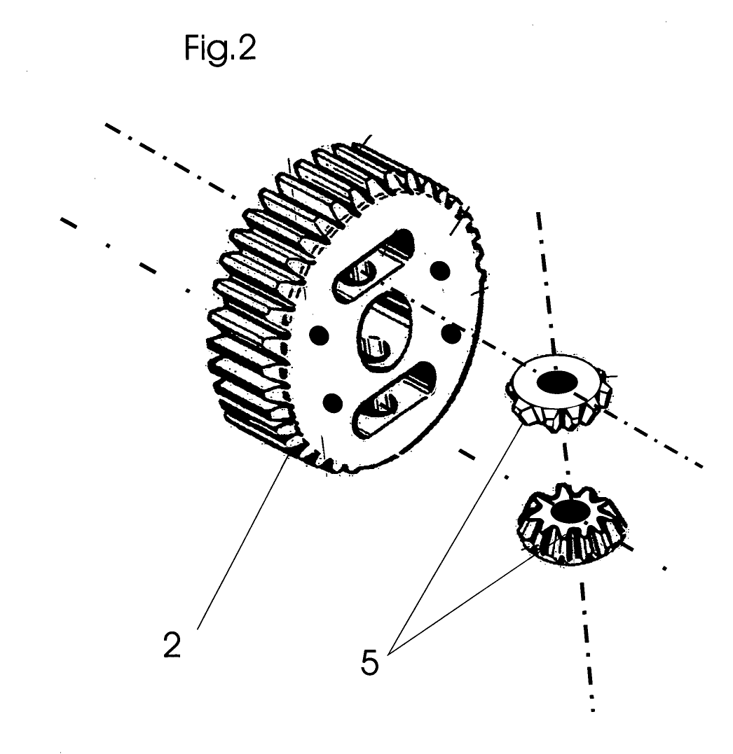

As we can see in the FIGS. 1 and 2 the present invention refers to a mechanical transmission box (1), composed by one or more satellite gear head boxes (2) connected to the input (3) and output (4) for gears (5). The inversion of the movement, increase or decrease of the speed of rotation of the satellite boxes (2) are obtained by screws (6) connected to the same and driven by an electric motor (not shown) or other source of mechanical rotation (like the rotation from the engine or the output of the transmission).

The control of the transmission (1) will be preferably done by a microprocessor, programmed with specific algorithms for each gear of the transmission box (forward, neutral and reverse). This microprocessor controls the source of mechanical rotation that rotates the screws (6) and so controls the direction and speed of rotation, the increase, or decrease or even the reversal of rotation of the satellite gear head boxes (2), obtaining progressive reduction or multiplication movements.

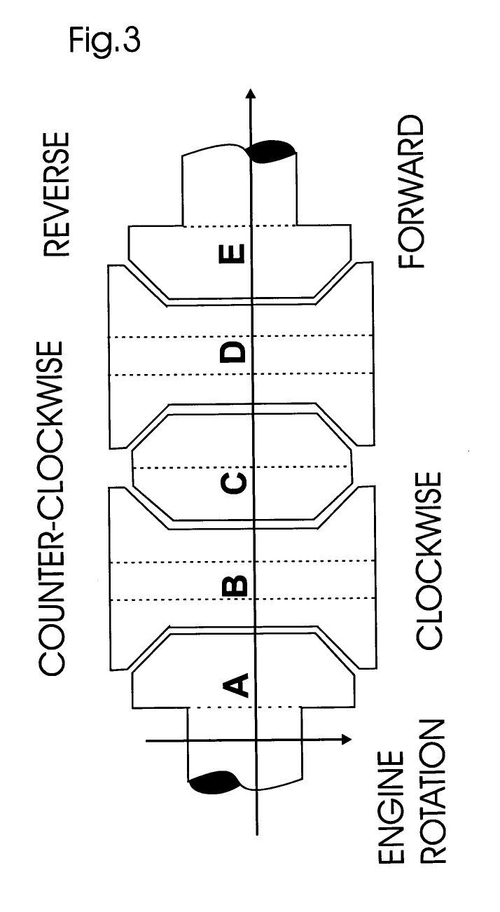

FIG. 3 illustrates in a schematic way the general operation of the invention. “A” receives the input rotation from the vehicle engine. In this particular example: one clockwise turn. The satellite B is rotated for the external screws and controls the entire transmission system. If the system of satellite B remains stationary “C” turns counter-clockwise. If the satellite B system makes a clockwise half turn the motion of “C” is null. If the system of satellite B makes one complete clockwise turn the planetary C will turn two laps counter-clockwise. The satellite system D works in a similar way to the satellite system B, influencing the planetary E which determines the movement which will be transmitted to the wheels

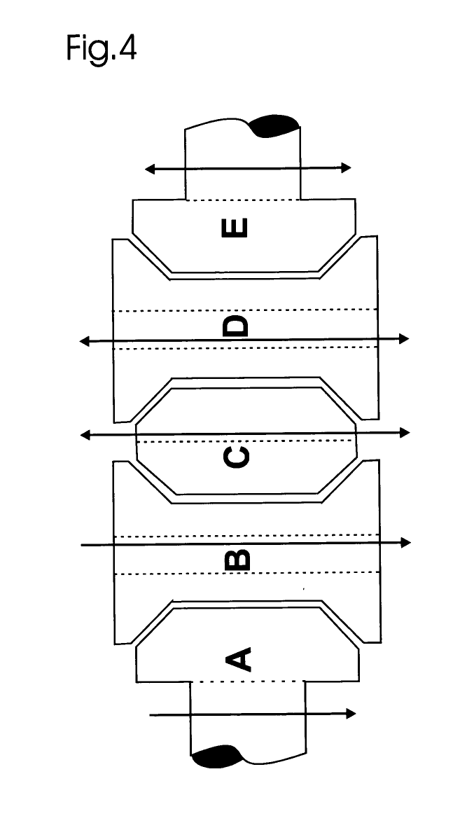

FIG. 4 illustrates the operation of the transmission in the neutral gear. On this example, the planetary A—which receives the input rotation from the engine—turns clockwise a complete lap. The satellite system B, whose rotation is controlled externally by screws, turns clockwise only half lap and, as a consequence, the planetary C stays still, the satellite system D stays still (as receives no motion of the planetary C) and the planetary E also stays still, not transmitting any motion to the wheels.

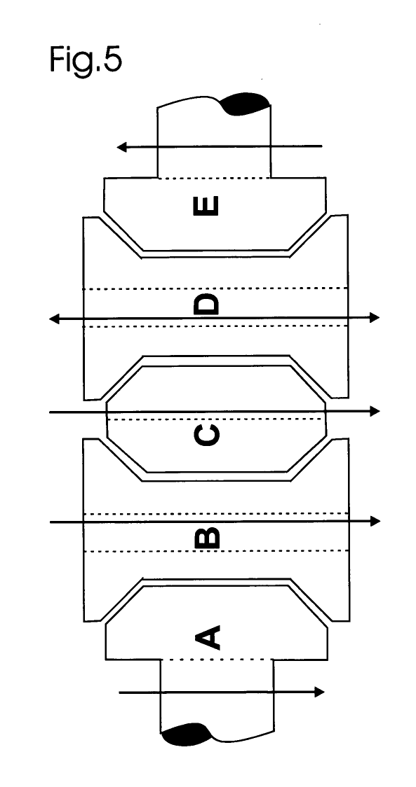

FIG. 5 illustrates the operation of the transmission in the reverse gear. In this example, the planetary A turns clockwise one lap. The satellite system B turns clockwise only half lap; the planetary C turns only the part commanded by the satellite system B. The satellite system D stays still and reverses the rotation of the planetary E which turns counter-clockwise and provides rotation to reverse gear.

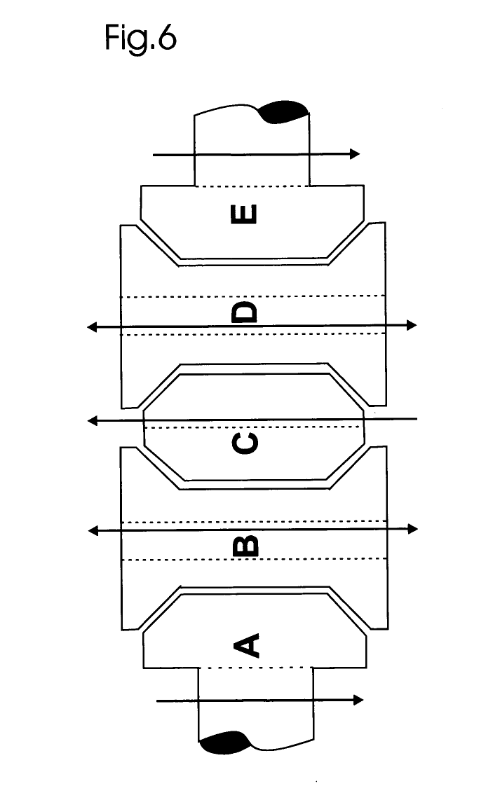

FIG. 6 illustrates the operation of the transmission in the forward gear. “A” turns clockwise. The satellite system B turns clockwise in a decreasing motion and causes an increasing progressive movement in C. The system of satellite D turns clockwise in a decreasing motion and E provides an increasing clockwise rotation.

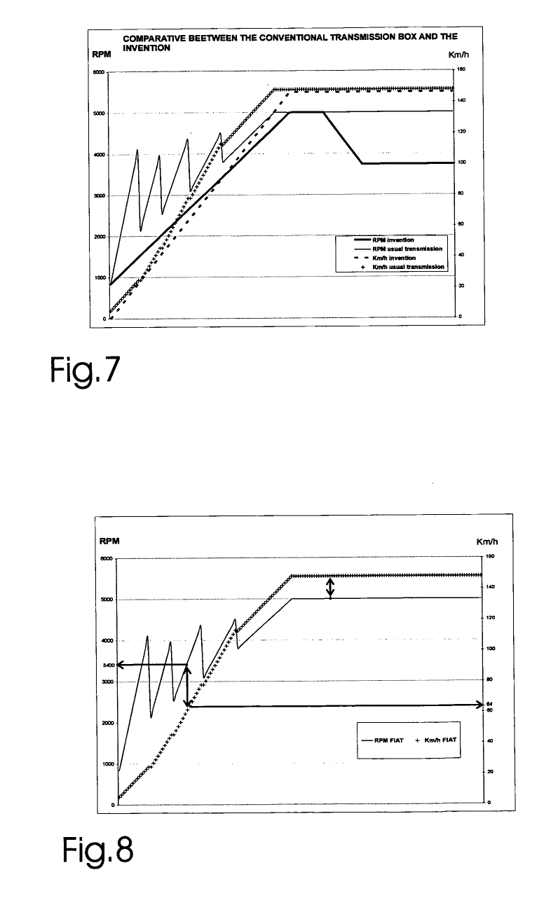

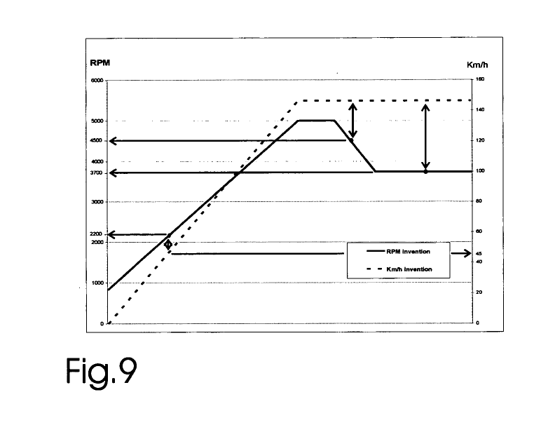

FIGS. 7 to 9 are graphs that compare the revealed invention with conventional transmission boxes. In this graphs we can clearly see the greater economy of the proposed transmission. In FIG. 7 are plotted the RPM and speed of a conventional transmission against the same data for the invention. In FIG. 8 are plotted only the data of the conventional transmission. In FIG. 9 are plotted only the data of the invention.

In the conventional transmission we see the variations that occur in the RPM of the engine as the speed of the vehicle increases, while in the invention the RPM variation of the engine increases in a continuous way as the speed of the vehicle increases. The rotations stabilize in a constant level and suffer a later decrease until reach and maintain another lower constant level.

1-4. (canceled)

5. A continuous transmission by a planetary gearhead: comprising one or more satellite gear head boxes connected to the input and output for gears, wherein with the inversion of the movement, increase or decrease of the speed of rotation of the satellite boxes is obtained by screws connected to the satellite boxes and is controlled externally by the rotation of a satellite B by the screws controlling the transmission and wherein the movement of the screws is controlled by a microprocessor programmed with specific algorithms for each gear of the transmission box.

6. The transmission according to claim 5, wherein of the transmission is operated in a neutral gear is obtained by rotating the satellite B in order to not transmit any movement to the rest of the transmission.

7. The transmission according to claim 5, wherein the transmission is operated in a reverse gear by rotating the satellite B in order to turn a planetary C in a way that maintains a satellite D still in order to reverse the rotation of a planetary E.

8. The transmission according to claim 5, wherein the transmission is operated in a forward gear by rotating the satellite B clockwise in a decreasing motion and causing an increasing progressive movement in a planetary C so a satellite D turns clockwise in a decreasing motion and a planetary E provides an increasing clockwise rotation.
